(19) United States
(12) Patent Application Publication
(10) Pub. No.: US 2026/0370698 A1
(43) Pub. Date: Nov. 19, 2026

(54) Core network access method and server for running core network

(71) Applicant: Saviah Technologies, Inc., Hsinchu City (TW)

(72) Inventors: YI-WEN LIU, Hsinchu City (TW); YU-SHENG LIU, Hsinchu City (TW)

(21) Appl. No.: 19/576,367

(22) Filed: Mar. 24, 2026

(30) Foreign Application Priority Data
May 15, 2025 (TW) 114118349

(51) Int. Cl. H04L 65/1069; H04L 9/40; H04L 61/5007

(52) U.S. Cl. CPC H04L 65/1069; H04L 61/5007; H04L 63/08

(57) ABSTRACT

A core network access method, which is used to connect user equipment (UE) to a core network, includes the following steps: receiving an Internet Protocol (IP) configuration request sent by the UE, where the IP configuration request includes network equipment information of the UE; querying an identity data of the UE from the core network using the network equipment information; requesting an authentication subscriber data from the core network using the identity data of the UE; performing a registration process; performing an authentication and security procedure using the authentication subscriber data; establishing a Protocol Data Unit (PDU) session; and completing an IP configuration procedure.

### BACKGROUND OF THE INVENTION

### 1.Field of the Invention

The present invention generally relates to mobile communication technology, and more particularly, to a core network access method and a server for running the core network.

### 2. Description of Related Art

In the 5^{th}-Generation Mobile Communication Technology (5G) network, user equipment (UE) (including, but not limited to, a smartphone, an Internet of Things (IoT) device) can access services provided by a 5G core network by establishing a connection with the 5G core network. A Non-3^{rd} Generation Partnership Project (non-3GPP) access network provides a solution that allows equipment not conforming to 3GPP standards to leverage existing network technologies and architectures (legacy networks) for accessing the 5G network and enjoying the services provided by the 5G network. According to the 3GPP specification, although a non-5G-capable over wireless local area network (WLAN) device can access the 5G core network through a Trusted WLAN Access Point (TWAP), the Extensible Authentication Protocol Method for 3^{rd} Generation Authentication and Key Agreement Prime (EAP-AKA') between the 5G core network and the non-5G-capable over WLAN device imposes some restrictions on application scenarios. For example, the TWAP must support the IEEE 802.1X standard, and the non-5G-capable over WLAN device must possess partial functions of a Universal Mobile Telecommunication Service (UMTS) Subscriber Identity Module (SIM) (hereinafter referred to as the USIM). That is to say, the non-5G-capable over WLAN device must have the USIM function and also needs to support the EAP-AKA' method. These requirements limit the application and development of the mobile communication network.

The aforementioned non-5G-capable over WLAN device may refer to a device that supports WLAN access technology but does not support a Non-Access Stratum (NAS) signaling and has the USIM function.

### SUMMARY OF THE INVENTION

In view of the issues of the prior art, an object of the present invention is to provide a core network access method and a server for running a core network, so as to make an improvement to the prior art.

According to one aspect of the present invention, a core network access method is provided. The core network access method is configured to connect user equipment (UE) to a core network and includes the following steps: receiving an Internet Protocol (IP) configuration request sent by the UE, wherein the IP configuration request includes network equipment information of the UE; querying an identity data of the UE from the core network using the network equipment information; requesting an authentication subscriber data from the core network using the identity data of the UE; performing a registration process; performing an identity authentication and security procedure using the authentication subscriber data; establishing a Protocol Data Unit (PDU) session; and completing an IP configuration procedure.

According to another aspect of the present invention, a server is provided. The server is configured to run a core network and to allow user equipment (UE) to connect thereto. The server includes a storage circuit and a computing circuit. The storage circuit is configured to store a plurality of program codes and/or program instructions. The computing circuit is coupled to the storage circuit and configured to perform the following steps: receiving an Internet Protocol (IP) configuration request sent by the UE, wherein the IP configuration request includes network equipment information of the UE; querying an identity data of the UE from the core network using the network equipment information; requesting an authentication subscriber data from the core network using the identity data of the UE; performing a registration process; performing an identity authentication and security procedure using the authentication subscriber data; establishing a Protocol Data Unit (PDU) session; and completing an IP configuration procedure.

The technical means embodied in the embodiments of the present invention can solve at least one of the problems of the prior art. Therefore, compared to the prior art, the present invention can enhance the application and development of mobile communication networks.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a schematic diagram of a 5G network according to an embodiment of the present invention.

FIG. 2 is the sequence diagram of the core network access method according to an embodiment of the present invention.

FIG. 3A to FIG. 3C are flowcharts of a core network access method according to an embodiment of the present invention.

FIG. 4 is a flowchart of transmitting a data packet according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a core network access method and a server for running the core network. On account of that some or all elements of the server could be known, the detail of such elements is omitted provided that such detail has little to do with the features of this disclosure, and that this omission nowhere dissatisfies the specification and enablement requirements. Some or all of the processes of the core network access method may be implemented by software and/or firmware and can be performed by the server or its equivalent. A person having ordinary skill in the art can choose components or steps equivalent to those described in this specification to carry out the present invention, which means that the scope of this invention is not limited to the embodiments in the specification.

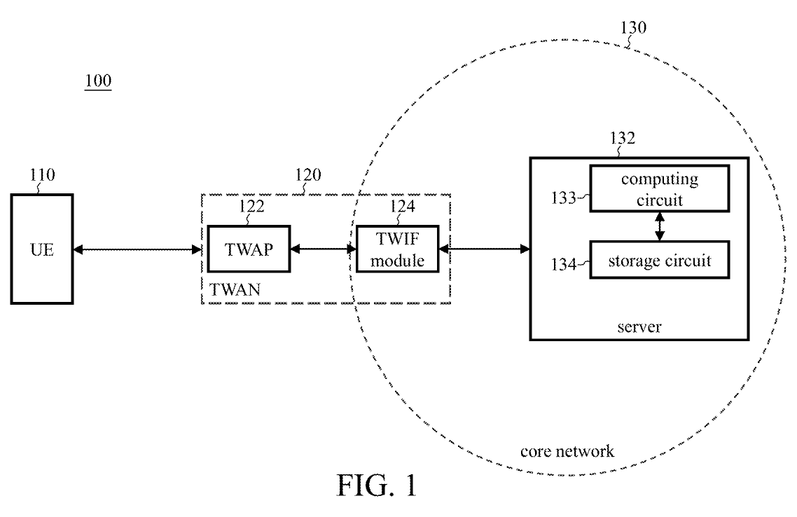

FIG. 1 is a schematic diagram of a 5G network according to an embodiment of the present invention. The 5G network 100 includes UE 110, a TWAN 120, and a core network 130.

The UE 110 is a legacy non-3GPP device. Legacy non-3GPP devices are network devices that do not support 3GPP and do not support the 802.1X protocol, and the network devices include devices that support a wireless local area network (WLAN) or a local area network (LAN). The TWAN 120 serves as a bridge between the UE 110 and the core network 130, enabling the UE 110 to access the core network 130.

The TWAN 120 includes a TWAP 122 and a trusted WLAN interworking function (TWIF) module 124.

The core network 130 includes a server 132 and the TWIF module 124. The server 132 includes a computing circuit 133 and a storage circuit 134 (including, but not limited to, volatile memory and/or non-volatile memory) that are coupled to each other. The computing circuit 133 may be a circuit or an electronic component with program execution capability, such as a central processing unit, a microprocessor, a microprocessor unit, a digital signal processor, an application specific integrated circuit (ASIC), or an equivalent circuit thereof. The computing circuit 133 implements all or some of the functions of the core network 130 by executing the program codes and/or the program instructions stored in the storage circuit 134. In other words, all or part of the core network 130 runs on the server 132.

The server 132 may refer to a single server or a server network composed of multiple servers. That is to say, multiple network function (NF) modules (including, but not limited to, the TWIF module 124, an Access and Mobility Management Function (AMF) module, an Authentication Server Function (AUSF) module, a Unified Data Repository (UDR) module, and a User Plane Function module) of the core network 130 can be deployed on one or more servers.

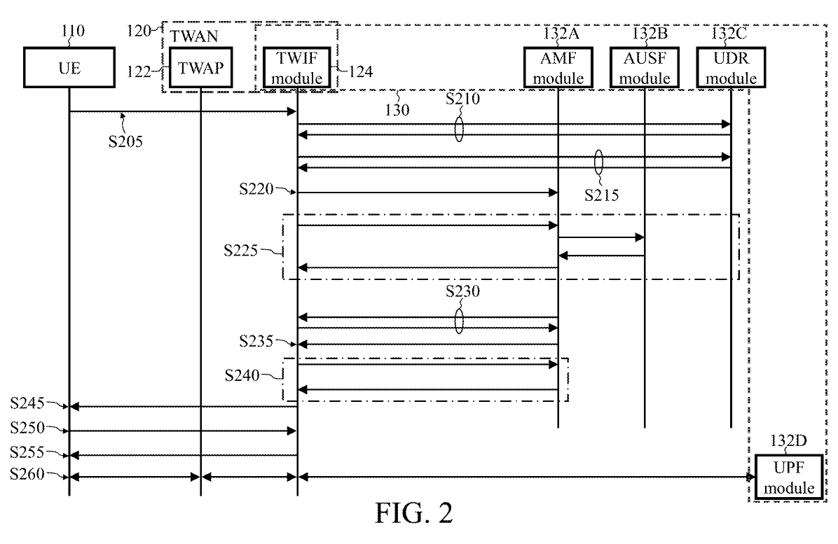

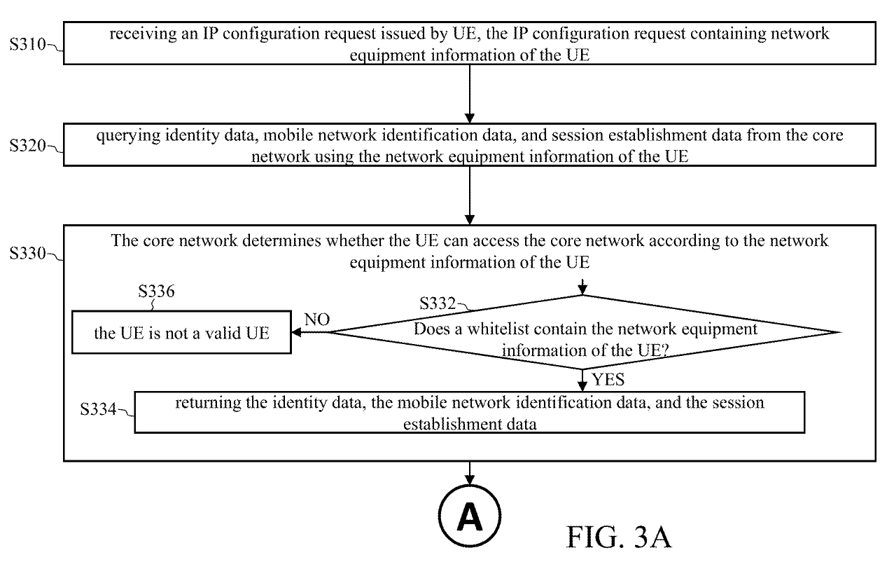

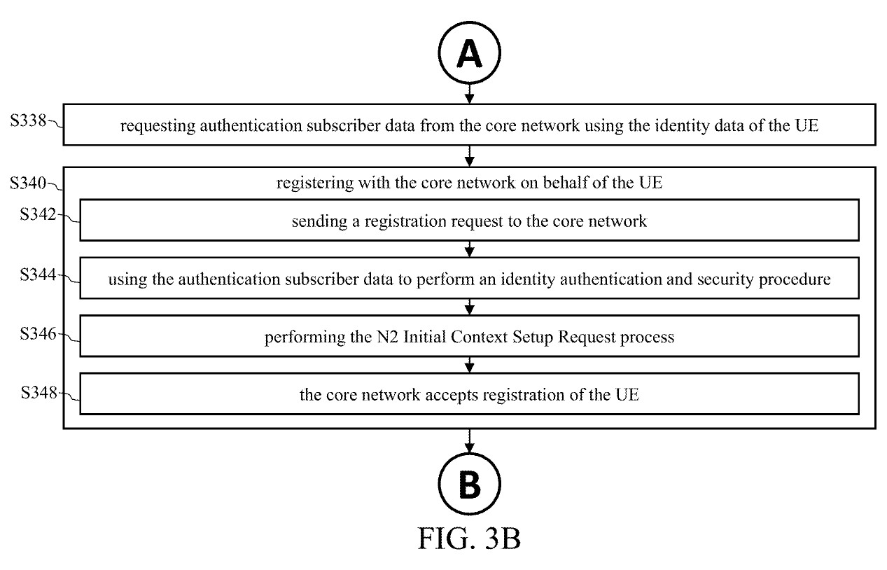

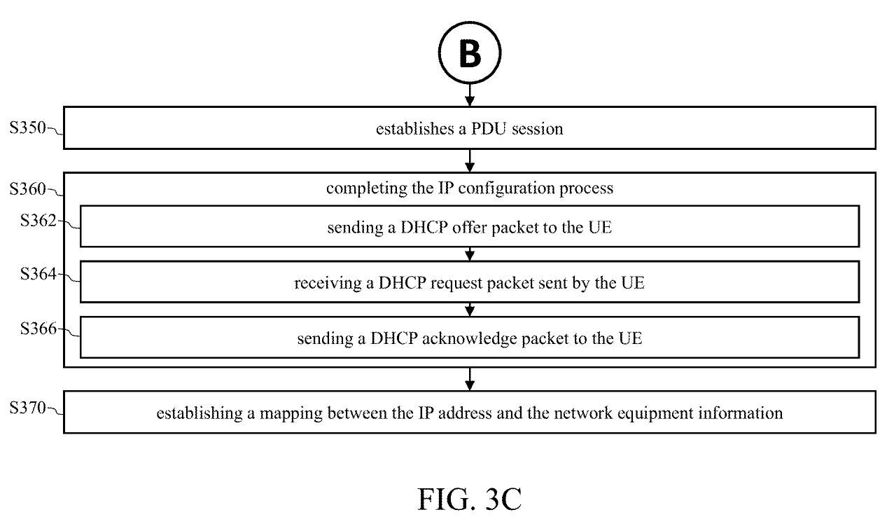

FIG. 2 is the sequence diagram of the core network access method according to an embodiment of the present invention. FIG. 3A to FIG. 3C are flowcharts of a core network access method according to an embodiment of the present invention. Refer to FIG. 2 and FIGS. 3A to 3C for the following discussion. The flow of FIG. 3A to FIG. 3C includes the following steps.

Step S310: The TWIF module 124 receives an Internet Protocol (IP) configuration request issued by the UE 110. This step corresponds to step S205 in FIG. 2. This IP configuration request contains network equipment information of the UE 110 (more specifically, information related to a Network Interface Card (NIC)), for example, a Media Access Control (MAC) address. In some embodiments, the TWAN 120 supports a Dynamic Host Configuration Protocol (DHCP), and the IP configuration request sent by the UE 110 is a DHCP discover packet.

Step S320: The TWIF module 124 queries identity data, mobile network identification data, and session establishment data from the core network 130 (more specifically, the UDR module 132C) using the network equipment information of the UE 110. This step corresponds to step S210 in FIG. 2.

In some embodiments, the identity data may be a Subscription Permanent Identifier (SUPI) or an International Mobile Subscriber Identity (IMSI).

In some embodiments, the mobile network identification data may be a Public Land Mobile Network Identifier (PLMN ID). The PLMN ID is used to identify the mobile network, which allows the TWIF module 124 to know which 5G core network to register with when the TWIF module 124 registers on behalf of the UE 110.

In some embodiments, the session establishment data includes but is not limited to Single Network Slice Selection Assistance Information (S-NSSAI) and a Data Network Name (DNN). The S-NSSAI enables the TWIF module 124 to ensure that the PDU session is established on a correct slice to support different Quality of Service (QoS) requirements when the TWIF module 124 establishes a Protocol Data Unit (PDU) session on behalf of the UE 110. The DNN enables the TWIF module 124 to determine which data network (e.g., the Internet, an enterprise private network, etc.) the PDU session connects to when the TWIF module 124 establishes the PDU session on behalf of the UE 110.

Step S330: The core network 130 (more specifically, the UDR module 132C) determines whether the UE 110 can access the core network 130 according to the network equipment information of the UE 110 (including, but not limited to, the MAC address of the UE 110). This step corresponds to step S210 in FIG. 2. In some embodiments, a whitelist is included in the UDR module 132C. UE in the whitelist is allowed to access the core network 130; conversely, UE not in the whitelist is not allowed to access the core network 130. Step S330 includes sub-steps S332 to S336.

Step S332: The UDR module 132C determines whether the whitelist contains the network equipment information of the UE 110. If YES, then the flow proceeds to step S334; otherwise, it means that the UE is not a valid UE (step S336), so the TWIF module 124 rejects the UE 110 from accessing the core network 130. For example, the core network 130 includes a look-up table that records the correspondence between a MAC address and a SUPI and/or an IMSI. In this step, the UDR module 132C checks whether the look-up table records the MAC address of the UE 110 (i.e., the network equipment information of the UE 110).

Step S334: The core network 130 (more specifically, the UDR module 132C) returns the identity data, the mobile network identification data, and the session establishment data linked to the MAC address.

Step S338: The TWIF module 124 requests authentication subscriber data from the core network 130 (more specifically, the UDR module 132C) using the identity data of the UE 110. This step corresponds to step S215 in FIG. 2. The authentication subscriber data includes an authentication key (i.e., a key identifier (Ki), hereinafter referred to as the K value) and a derived operator code (hereinafter referred to as the OPc value). The K value and the OPc value are part of data in the SIM card. However, because a legacy non-3GPP device (e.g., the UE 110) does not have a SIM card, the K value and the OPc value are stored in the UDR module 132C in this disclosure.

Step S340: The TWIF module 124 registers with the core network 130 on behalf of the UE 110. Step S340 includes sub-steps S342 to S348.

Step S342: The TWIF module 124 sends a registration request to the core network 130 (more specifically, the AMF module 132A). This step corresponds to step S220 in FIG. 2. This step is a step specified by the 3GPP standard, so a further elaboration is omitted for brevity.

Step S344: The TWIF module 124 uses the authentication subscriber data to perform an identity authentication and security procedure. This step corresponds to step S225 in FIG. 2. This step includes an interaction between the TWIF module 124 and the AMF module 132A, and an interaction between the AMF module 132A and the AUSF module 132B. This step is a step specified by the 3GPP standard, so a further elaboration is omitted for brevity.

Step S346: Performing the N2 Initial Context Setup Request process. This step corresponds to step S230 in FIG. 2. This step is a step specified by the 3GPP standard, so a further elaboration is omitted for brevity.

Step S348: The core network 130 (more specifically, the AMF module 132A) accepts registration of the UE 110. This step corresponds to step S235 in FIG. 2.

Step S350: The TWIF module 124 establishes a PDU session with the core network 130 (more specifically, the AMF module 132A). This step corresponds to step S240 in FIG. 2. This step is a step specified by the 3GPP standard, so a further elaboration is omitted for brevity.

Step S360: The TWIF module 124 completes the IP configuration process. The following uses DHCP as an example to illustrate step S360 (including sub-steps S362 to S366).

Step S362: The TWIF module 124 sends a DHCP offer packet to the UE 110. This step corresponds to step S245 in FIG. 2.

Step S364: The TWIF module 124 receives a DHCP request packet sent by the UE 110. This step corresponds to step S250 in FIG. 2.

Step S366: The TWIF module 124 sends a DHCP acknowledge packet to the UE 110. This step corresponds to step S255 in FIG. 2.

Steps S362 to S366 are steps specified by the DHCP standard, so a further elaboration is omitted for brevity. After step S360 ends, the UE 110 can obtain an IP address.

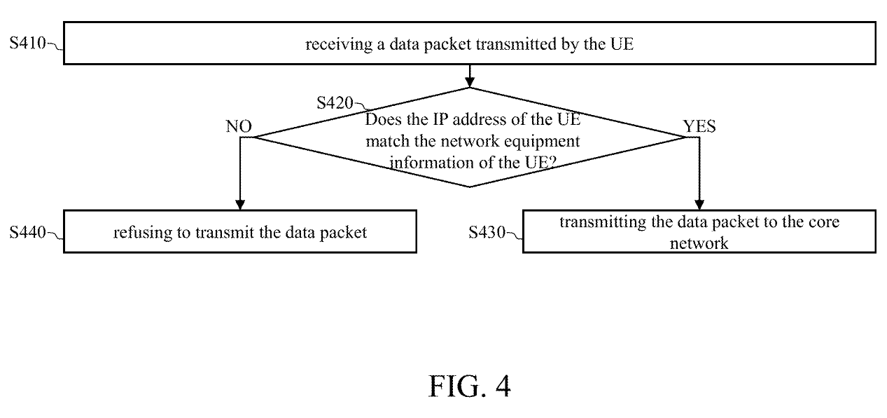

Step S370: The TWIF module 124 then establishes a mapping between the IP address and the network equipment information (e.g., a MAC address) of the UE 110. In subsequent procedures, the TWIF module 124 can determine whether the IP address of the UE 110 is being impersonated based on this mapping (to be detailed below with reference to FIG. 4).

FIG. 4 is a flowchart of transmitting a data packet according to an embodiment of the present invention. The process of FIG. 4 includes the following steps.

Step S410: Receiving a data packet transmitted by the UE.

Step S420: determining, based on the mapping established in step S370, whether the IP address of the UE matches the network equipment information (e.g., the MAC address) of the UE. If YES, the flow proceeds to step S430; otherwise, the flow proceeds to step S440. More specifically, if the IP address of the UE matches the network equipment information (which indicates that the UE is a valid UE (i.e., the UE 110, which has completed the core network access method of FIGS. 3A to 3C)), then the TWIF module 124 allows the UE to access the core network 130. If the IP address of the UE does not match the network equipment information (which indicates that the UE is not the UE 110 and is impersonating the UE 110 by using the IP address obtained by the UE 110 in step S360), then the TWIF module 124 rejects the UE from accessing the core network 130.

Step S430: The TWIF module 124 transmits data packets between the UE 110 and the core network 130 (more specifically, the UPF module 132D). This step corresponds to step S260 in FIG. 2. In other words, the UE 110 has been allowed to access the core network 130.

Step S440: The TWIF module 124 refuses to transmit the data packet.

In some embodiments, the TWIF module 124, the AMF module 132A, the AUSF module 132B, the UDR module 132C, and the UPF module 132D may be stored in the storage circuit 134 of the server 132 in the form of program codes and/or program instructions.

In summary, the core network access method of the present invention does not need to implement EAP-AKA', so that a legacy non-3GPP device without the USIM function can also access the 5G core network, greatly enhancing the application and development of the mobile communication network. In comparison with the traditional core network access process based on EAP-AKA', the core network access method of the present disclosure is more applicable to a closed 5G core network with lower security requirements (e.g., an enterprise private network), thereby enhancing the support of the 5G core network for UE.

The 5G network is intended to illustrate the invention by way of example and not to limit the scope of the claimed invention. People having ordinary skill in the art may apply the present invention to other types or other generations of mobile networks in accordance with the foregoing discussions.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A core network access method for connecting user equipment (UE) to a core network, comprising following steps:
receiving an Internet Protocol (IP) configuration request sent by the UE, the IP configuration request comprising network equipment information of the UE;
querying an identity data of the UE from the core network using the network equipment information;
requesting an authentication subscriber data from the core network using the identity data of the UE;
performing a registration process;
performing an identity authentication and security procedure using the authentication subscriber data;
establishing a Protocol Data Unit (PDU) session; and
completing an IP configuration procedure.

2. The method of claim 1, wherein the network equipment information is a Media Access Control (MAC) address.

3. The method of claim 1, wherein the step of completing the IP configuration procedure generates an IP address, and the method further comprises:
receiving a data packet from the UE;
checking whether the network equipment information of the UE matches the IP address; and
when the network equipment information matches the IP address, transmitting the data packet to the core network.

4. The method of claim 1, wherein the identity data is an International Mobile Subscriber Identity (IMSI).

5. The method of claim 1, wherein the identity data is a Subscription Permanent Identifier (SUPI).

6. The method of claim 1, further comprising:
querying a mobile network identification data and a session establishment data from the core network using the network equipment information.

7. The method of claim 6, wherein the mobile network identification data is a Public Land Mobile Network Identifier (PLMN ID), and the session establishment data comprises a Single Network Slice Selection Assistance Information (S-NSSAI) and a Data Network Name (DNN).

8. The method of claim 1, wherein the authentication subscriber data comprises a key identifier and a derived operator code.

9. The method of claim 1, wherein the core network is a 5G core network, and the UE is a legacy Non-3^{rd} Generation Partnership Project (non-3GPP) device.

10. A server configured to run a core network and allow UE to connect, comprising:
a storage circuit configured to store a plurality of program codes and/or program instructions; and
a computing circuit coupled to the storage circuit and configured to perform following steps:
receiving an Internet Protocol (IP) configuration request sent by the UE, the IP configuration request comprising network equipment information of the UE;
querying an identity data of the UE from the core network using the network equipment information;
requesting an authentication subscriber data from the core network using the identity data of the UE;
performing a registration process;
performing an identity authentication and security procedure using the authentication subscriber data;
establishing a Protocol Data Unit (PDU) session; and
completing an IP configuration procedure.

11. The server of claim 10, wherein the network equipment information is a Media Access Control (MAC) address.

12. The server of claim 10, wherein the step of completing the IP configuration procedure generates an IP address, and the computing circuit is further configured to perform following steps:
receiving a data packet from the UE;
checking whether the network equipment information of the UE matches the IP address; and
when the network equipment information matches the IP address, transmitting the data packet to the core network.

13. The server of claim 10, wherein the identity data is an International Mobile Subscriber Identity (IMSI).

14. The server of claim 10, wherein the identity data is a Subscription Permanent Identifier (SUPI).

15. The server of claim 10, further comprising:
querying a mobile network identification data and a session establishment data from the core network using the network equipment information.

16. The server of claim 15, wherein the mobile network identification data is a Public Land Mobile Network Identifier (PLMN ID), and the session establishment data comprises a Single Network Slice Selection Assistance Information (S-NSSAI) and a Data Network Name (DNN).

17. The server of claim 10, wherein the authentication subscriber data comprises a key identifier and a derived operator code.

18. The server of claim 10, wherein the core network is a 5G core network, and the UE is a legacy Non-3^{rd} Generation Partnership Project (non-3GPP) device.
